(19) United States
(12) Patent Application Publication
(10) Pub. No.: US 2018/0153098 A1
(43) Pub. Date: Jun. 7, 2018

(54) ROTARY SCISSORING MOWER

(71) Applicant: Robert N. DeJong, London (CA)

(72) Inventor: Robert N. DeJong, London (CA)

(21) Appl. No.: 15/828,659

(22) Filed: Dec. 1, 2017

Related U.S. Application Data
(60) Provisional application No. 62/429,352, filed on Dec. 2, 2016.

(51) Int. Cl. A01D 34/57; A01D 34/46; A01D 34/54

(52) U.S. Cl. CPC A01D 34/57; A01D 34/58; A01D 34/54; A01D 34/46

(57) ABSTRACT

A disclosed example scissoring mower includes a cutting assembly driven by a gear system. The mower is moved by an operator or motor to cause rotation of wheels. The wheels are coupled to an axle that drives the gear system and thereby the cutting assembly. Accordingly, when the mower is pushed or driven forward, the gear system causes blades of the cutting assembly to move in opposite directions, creating a scissoring action that cuts grass and other vegetation.

### CROSS REFERENCE TO RELATED APPLICATION

The application claims priority to U.S. Provisional Application No. 62/429,352 which was filed on Dec. 2, 2016.

### BACKGROUND

Rotary-cutting shear mowers use engines to rotate a single blade at high speed. The motor may be electric or gas and wastes energy when powered on and not cutting grass. Moreover, the gas powered mower is loud and emits exhaust fumes. A reel motor is manually operated but is often unable to cut vegetation of varying heights and may require excessive effort.

### SUMMARY

A disclosed rotary scissoring mower is timed with travel and does not need high cutting speeds to cut grass and weeds, nor does the disclosed example mower require excessive energy to accelerate to cutting speed. The rotary scissoring mower can cut vegetation of varying heights within a lawn.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a perspective view of an example mower.

FIG. 2 is a side view of the example mower.

FIG. 3 is a front view of the example mower.

FIG. 4 is an exploded view of an example adjusting mechanism.

FIG. 5 is an exploded view of a driving assembly for the example mower.

FIG. 6 is a perspective view of an example gearbox and cutting assembly.

FIG. 7 is a cross-section of the example gearbox and cutting assembly.

FIG. 8 is an exploded view of the example gearbox.

FIG. 9 is a sectional view of a blade drive assembly.

FIG. 10 is a partial cross-sectional view of the blade drive assembly.

FIG. 11 is a top view of the blade drive assembly.

FIG. 12 is an exploded view of an upper cutting blade assembly.

FIG. 13 is perspective view of an example knuckle.

FIG. 14 is a perspective view of an example blade locator.

FIG. 15 is an exploded view of the knuckle and shaft.

FIG. 16 is an exploded view of an example lower blade assembly.

FIG. 17 is an exploded view of a portion of the lower blade assembly.

FIG. 18 is a side view of an alternate embodiment of the mower.

FIG. 19 is a side view of another alternate embodiment of the mower.

FIG. 20 is a side view of yet another alternate embodiment of the mower.

### DETAILED DESCRIPTION

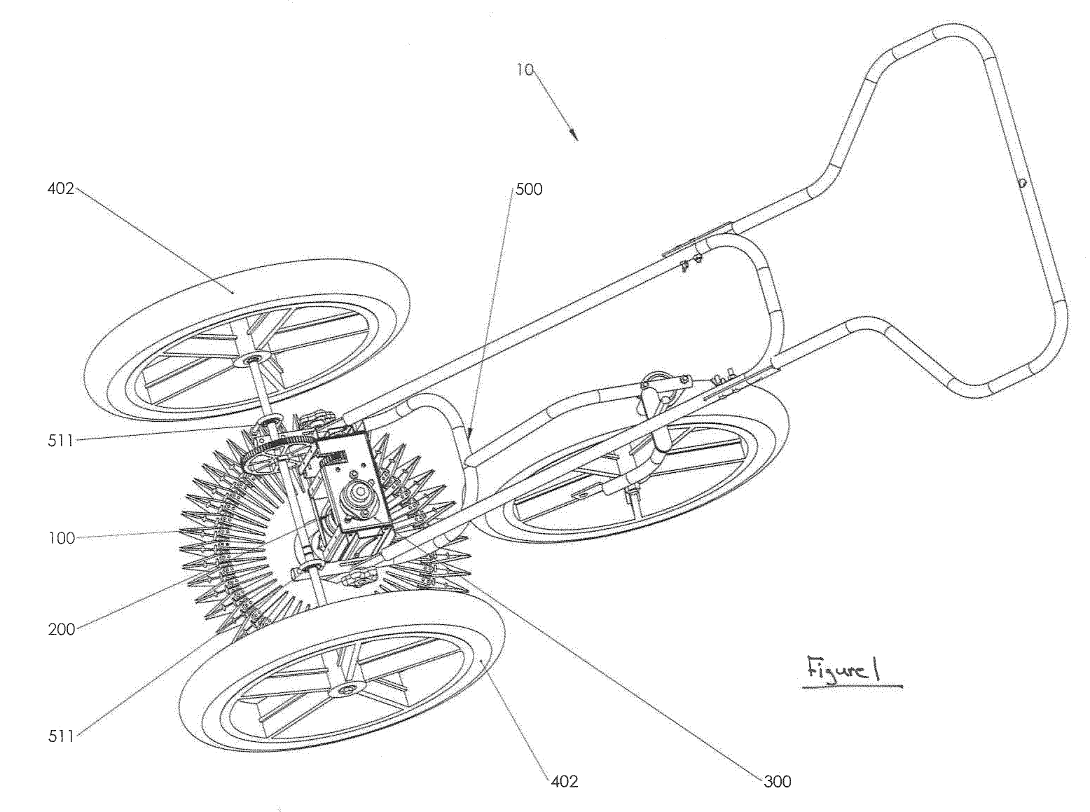

Referring to FIGS. 1, 2 and 3, an example scissoring mower 10 includes a cutting assembly 100 driven by a gear system 200 supported within a housing 300. The mower 10 is pushed by an operator to cause rotation of wheels 402. The wheels 402 are coupled to an axle that drives the gear system 200. The housing 300 is supported on a chassis 500. Accordingly, when the mower is pushed or driven forward, the gear system 200 causes blades of the cutting assembly 100 to move in opposite directions, creating a scissoring action that cuts grass and other vegetation.

The chassis 500 includes rail 501 supporting a rotatable rear fork 504 for a following wheel 505. Upper handle section 507 and lower handle section 506 are attached to the rail 501 and are adjustable to accommodate the operator.

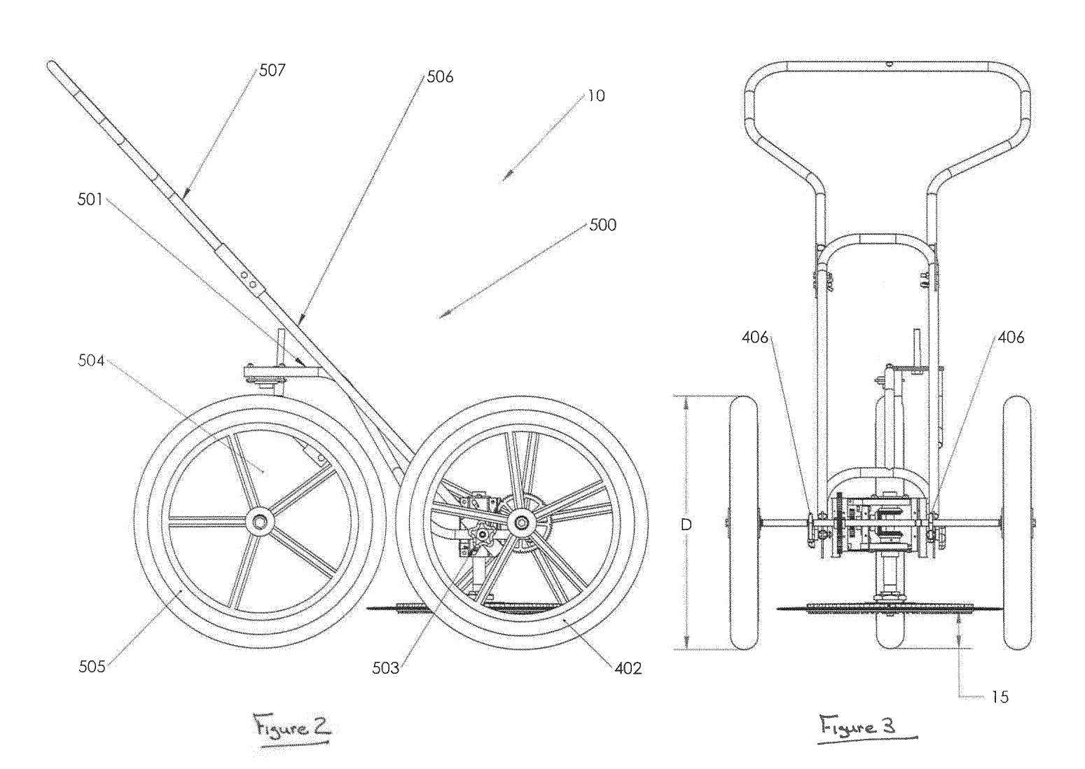

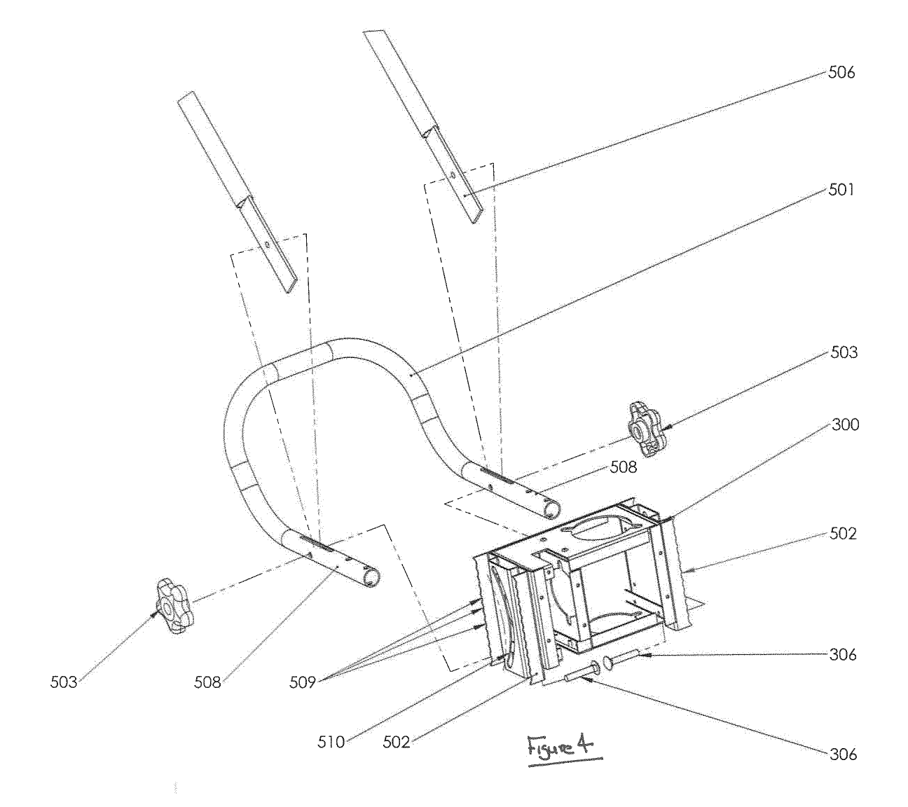

Referring to FIG. 4, with continued reference to FIGS. 2 and 3, a height 15 of the cutting assembly 100 is adjustable by changing a position of the housing 300 on the rail 501. Brackets 502 are secured to either side of the housing 300 and include slots 510 that receive bolts 306. The bolts 306 extend through the housing 300, slots 510 and ends 508 of the rail 501 and then are threaded into knobs 503. The ends 508 of the rail 501 are secured to the bracket 502 by tightening the knobs 503. The ends 508 of the rail 501 are received within one of the plurality of defined indentations 509 of the bracket 502 to set the desired cutting height 15 (FIG. 3). The lower handle section 506 is attached to a top portion of the rail 501.

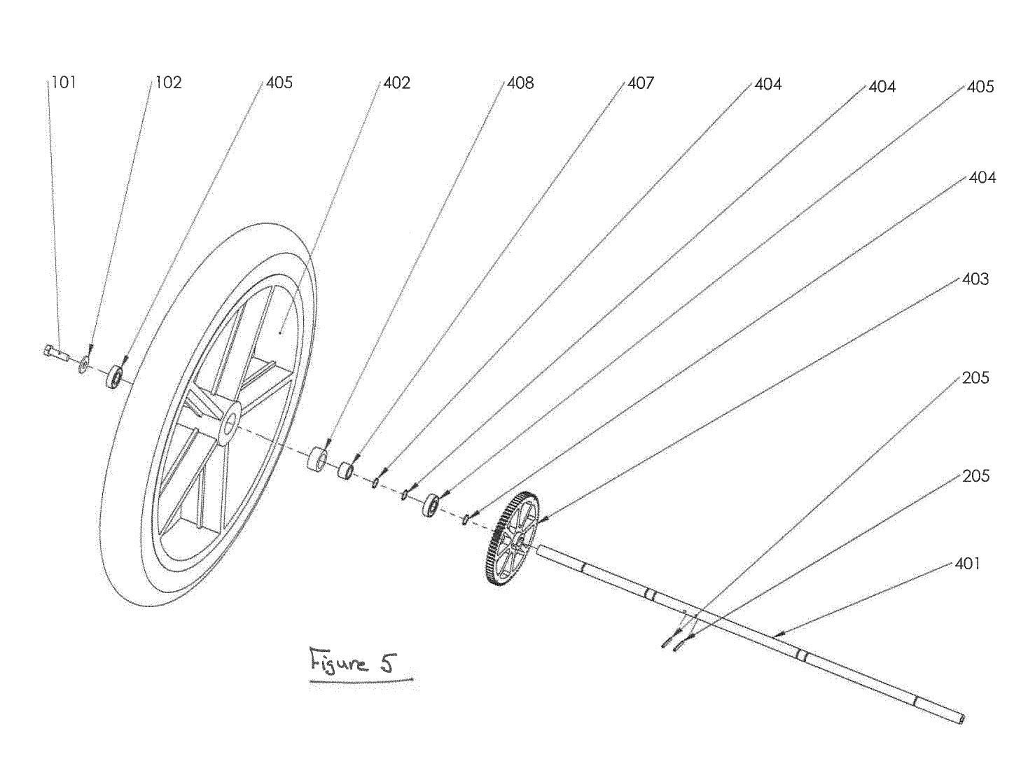

Referring to FIG. 5 with continued reference to FIGS. 1-4, an axle 401 is supported on ends 508 of the rail 501 with U-bolts 406 and bearings 405. A drive gear 403 is fixed to the axle 401 through a clutch assembly 512. The clutch assembly 512 includes a clutch bearing 407 and adaptor 408. The clutch assembly 512 couples the drive wheels 402 to the axle 401 such that rotation of the wheel 402 may rotate relative to the axle 401 to protect the gear system 200. The drive gear 403 is held in place on the axle 401 with snap rings 404 and bearing 405. The gear 403 is coupled to the axle 401 with spring pins 205. The wheel 402 is secured to the axle 401 by a bolt 101 and washer 102.

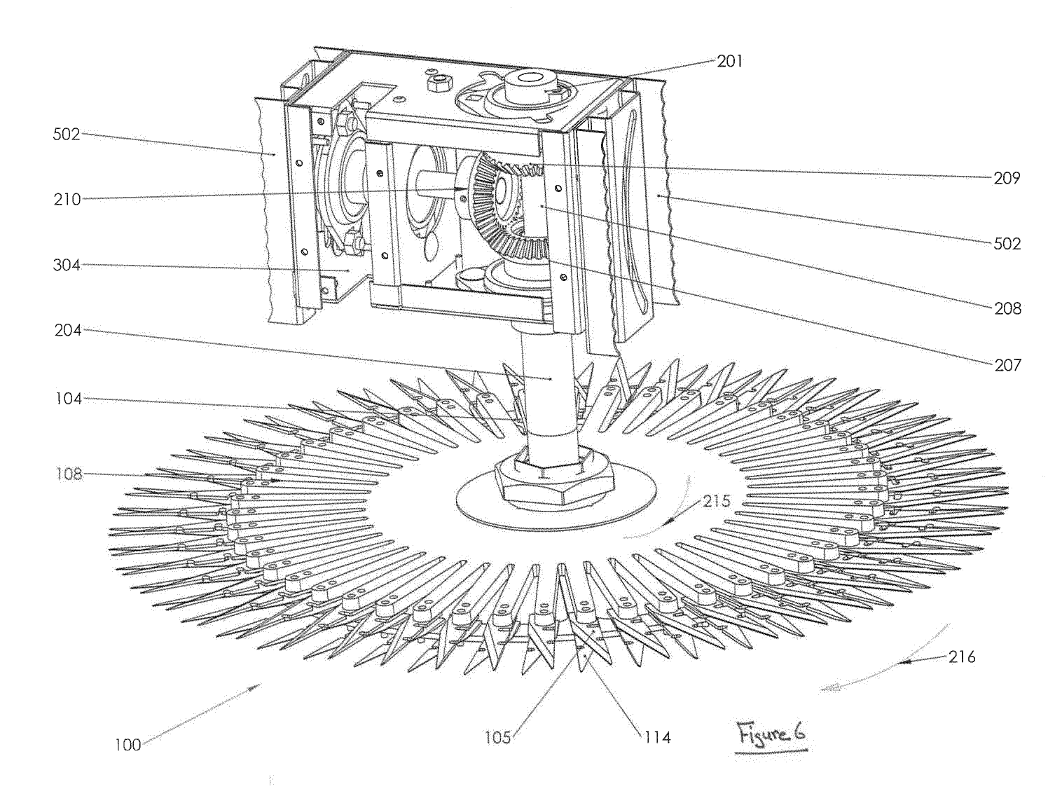

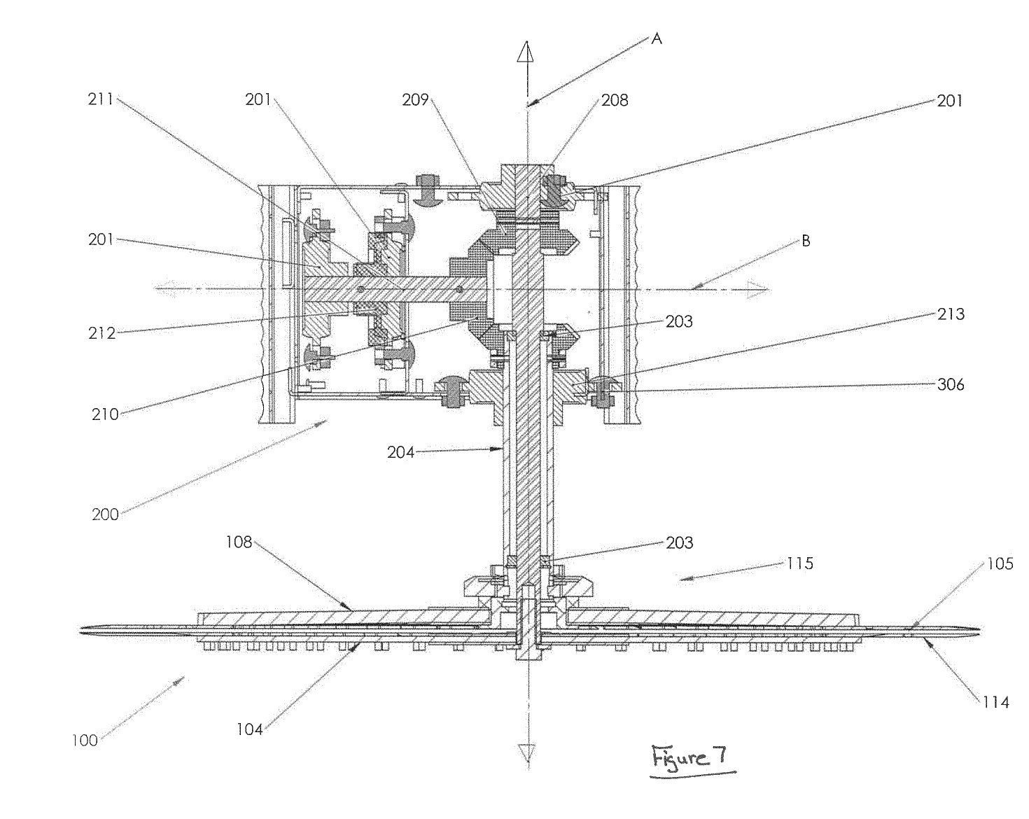

Referring to FIGS. 6, 7 and 8 the cutting assembly 100 and gear system 200 are supported by the housing 300. The cutting assembly 100 includes an upper carousel 108 driven by a first shaft 204 and a lower carousel 104 driven by a second shaft 208. The first shaft 204 is hollow and rotates about an axis A. The second shaft 208 is solid and extends through the first shaft 204 to rotate about the same axis A. Collars 203 are provided within the first shaft 204 to support the second shaft 208. The housing 300 includes a top bearing 201 that supports one end of the second shaft 208. A bottom bearing 213 supports the first shaft 204. A first gear 207 is attached to the first shaft 204 with a collar 206 and spring pins 205. A second gear 209 is attached to the second shaft 208. The first gear 207 and the second gear 209 are both driven by a drive gear 210. The drive gear 210 is coupled to a drive shaft 211 supported on bearings 201 within the housing 300. A first driven gear 212 is coupled to the drive shaft 211 and engaged to the drive gear 403 driven by the axle 401 (See FIG. 1). In this disclosed example, the drive shaft 211 is disposed along an axis B that is transverse to the axis A.

The example first gear 207, second gear 209 and the drive gear 210 are bevel or miter gears that have engaging teeth disposed at an angle relative to respective axis of rotation. Other gear configurations could be utilized and are within the contemplation of this disclosure.

The cutting assembly 100 is supported at ends of the first and second shafts 204, 208 and include a first set of blades 105 that are rotated in a first direction indicated by arrow 215. A second set of blades 114 is rotated in a second direction indicated by arrow 216 that is opposite the first direction. The first set of blades 105 therefore rotates in an opposite direction to the second set of blades 114 and defines a cutting zone between the first and second sets of cutting blades 104, 114.

The distance that the mower 10 is pushed is related to the rotation of the cutting blades 105, 114. To determine the according to the following equation.

To determine the effective distance per cutting event C, use the following formula:

$$\begin{matrix}C = Π * D / Nt * Nc * R \\ = Π * 20 / 48 * 2 * 2.24 \\ = 62.8 / 215.0 \\ = 0.292 inches of forward motion per cutting event\end{matrix}$$

Where D is the wheel diameter with tire;

Nt is the number of cutting blades per carousel;

Nc is the number of counter-rotating carousels; and

R is the Gear ratio.

In one disclosed example, D is 20 inches, Nt is 48, Nc is 2 and R is 2.24:1. This formula can be modified to account for additional cutting teeth, changes in gear ratio, diameter of drive wheels and cutting diameter. Moreover, reducing the gear ratio R enables a lower power input to produce a cutting action. The lower output may change a desired performance of cutting outside of a certain range. The changes in performance are due to the relationship between the cutting tooth interaction and distance required per cutting event C. Increasing the gear ratio R will require greater power input but will provide an improved quality of cut. It should be appreciated that other modifications to the gear system and cutting assembly including different dimensions and ratios for the various features are possible and within the contemplation of this disclosure.

The upper carousel 108 and the lower carousel 104 are supported at the ends of the first and second shafts and form part of a blade drive assembly 115. The blade drive assembly 115 provides relative rotation and a biasing force that keeps the first set of blades 105 in contact with the second set of blades 114. The biasing force between the first set of blades 105 and the second set of blades 114 provides a continuous sharpening function by maintaining contact with a sufficient force to provide for cutting and to maintain the cutting edges.

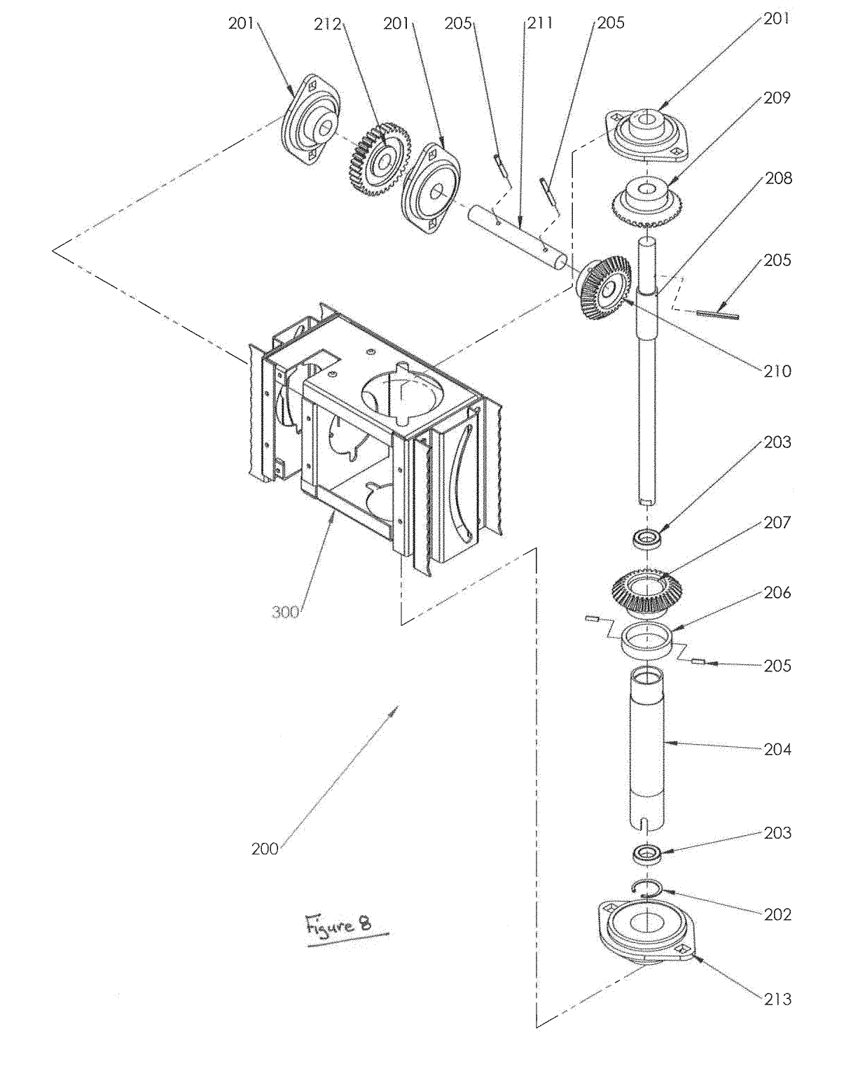

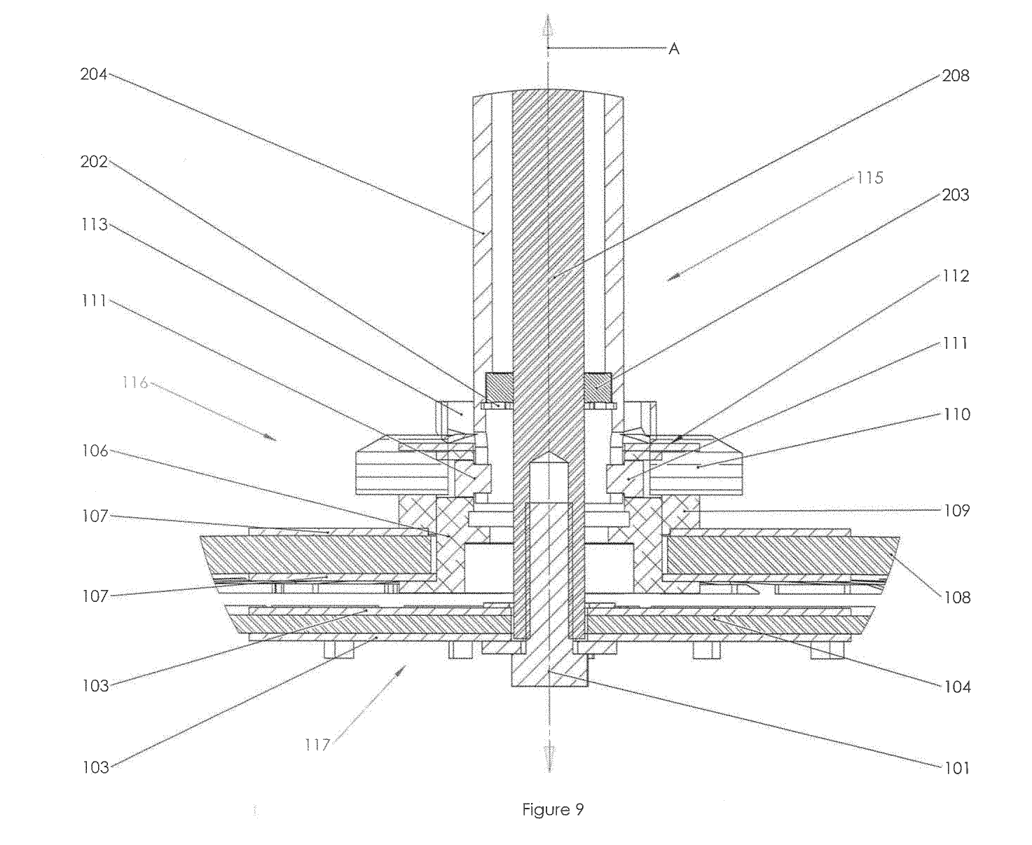

Referring to FIG. 9 with continued reference to FIGS. 6-8, the blade drive assembly 115 includes the upper carousel 108 and the lower carousel 104 that are supported on the corresponding first shaft 204 and the second shaft 208. The second shaft 208 is supported for rotation within the first shaft 204 by the collar 203 that is held in place by snap ring 202. The upper carousel 108 and the lower carousel 104 are plates to which the cutting blades 105, 114 are attached. As appreciated, the example cutting blades and carousels are separate parts, however, it is within the contemplation of this disclosure to integrate the blades and carousels into one common part. Moreover, the carousel and blades may be formed of several different components if desired and suitable for a specific application. The upper and lower carousels 108, 104 are not fixed to either of the shafts 204, 208 but are instead driven through friction plates 103 and 107 that are coupled and keyed to a corresponding one of the first and second shafts 204, 208.

The blade drive assembly 115 further includes biasing washer 112 that generates a biasing force on the upper carousel 108 downward against the lower carousel 104. The biasing force generated by the wave washer 112 provides the desired pressure between the first set of cutting blades 105 and the second set of cutting blades 114. The contact between the blades provides a self-sharpening feature that remove nicks and other discontinuities between the blades and continually sharpens the blades during operation.

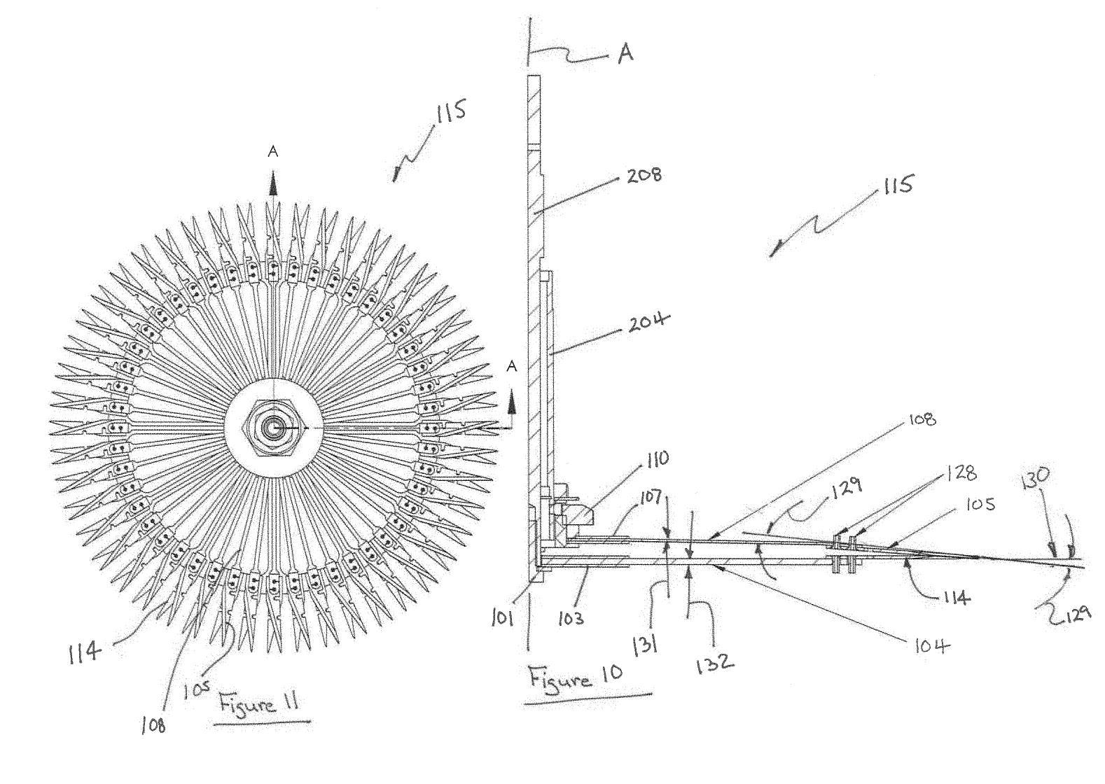

Referring to FIGS. 10 and 11 with continued reference to FIG. 9, the blade drive assembly 115 includes the upper carousel 108 that supports the first set of cutting blades 105. The upper carousel 108 is fabricated from a flexible steel material with a thickness 131. The thickness enables flexing relative to the stiffer and lower carousel 104. The lower carousel 104 is fabricated from a stiffer steel material with a thickness 132. The thinner thickness of the upper carousel 108 enables flexing that assures cutting contact between the first set of cutting blades 105 and the second set of cutting blades 114. Rivets 128 are used to attach the cutting blades 105, 114 to the corresponding upper and lower carousels 108, 104. Moreover, the first set of cutting blades 105 are mounted at an angle 129 relative to a plane 130 defined by the lower carousel 104. The disclosed angle 129 is greater than zero and less than eight (8) degrees. In another disclosed embodiment the angle 129 is greater than zero and less than about four (4) degrees. The combination of the flexible upper carousel 108 and the downward angle 129 generates cutting contact between the first set of cutting blades 105 and the second set of cutting blades 114. Moreover, the angle 129 combined with the flexible nature of the upper carousel 108 provide a spring biasing force downward against the second set of cutting blades 114.

Cutting Blades continually contact matching scissoring cutting blades during movement. Blades 105 attached to spring fingered upper carousel 108 individually springs down blades 105 onto matching blades 105 attached to lower carousel 104. As upper carousel 108 rotates opposite to lower carousel 104 then matching blades contact each other in a continuous scissoring motion.

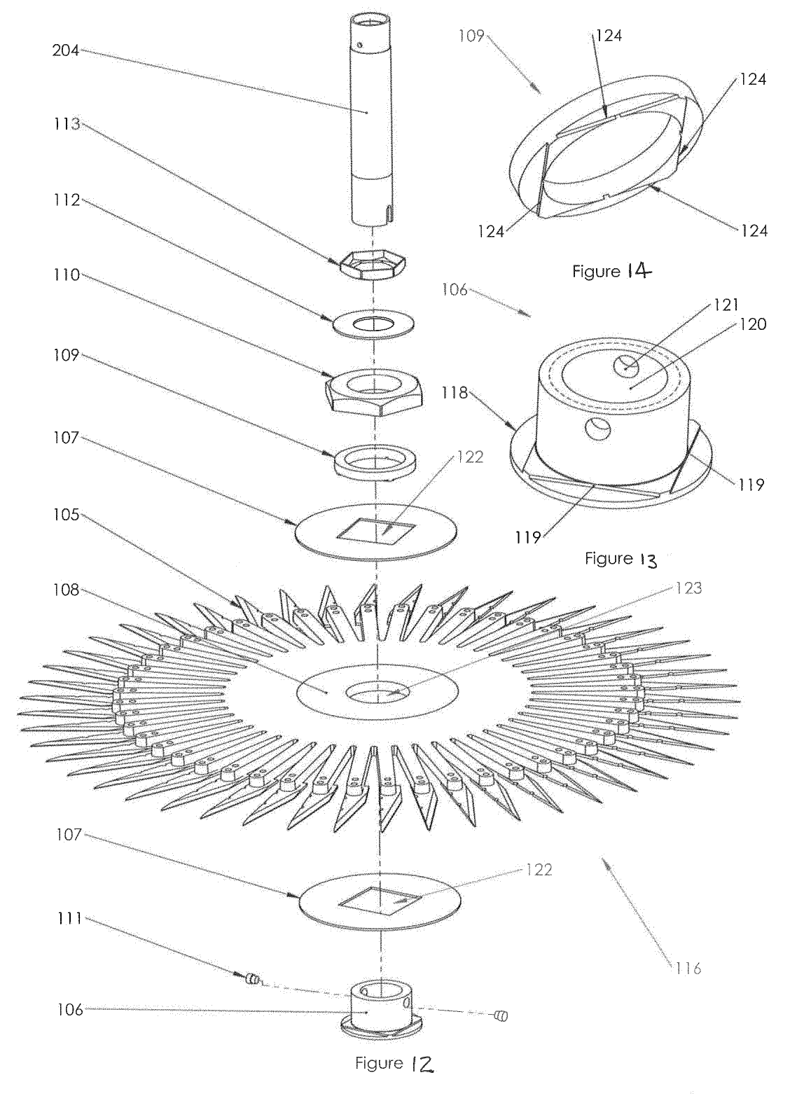

Referring to FIGS. 12, 13, 14 and 15 with continued reference to FIGS. 9 and 10, an example upper blade assembly 116 includes the first shaft 204 coupled to knuckle 106. The knuckle 106 includes a lower flange 118 that includes ridges 119 that define a rectangular mating edges that couple to a rectangular opening 122 in friction plates 107. The friction plates 107 are keyed to corresponding the ridges 119 provided on the flange 118 of the knuckle 106.

The knuckle 106 includes a bore 120 that receives an end of the first shaft 204. The first shaft 204 includes slots 217 that receive torque pins 111 disposed within openings 121 to transmit torque. The upper carousel 108 includes a circular opening 123 that is not coupled directly to the first shaft 204. The friction plates 107 are disposed on both the top and bottom of the upper carousel 108. An upper blade locator 109 is stacked atop the friction plate 107 on the top side of the carousel 108. The blade locator 109 includes ridges 124 that mate with the opening 122 in the friction plate 107. A retaining fastener 110 is attached to the knuckle 106 and a wavy washer 112 is stacked atop the retaining fastener 110. A pressure nut 113 is provided that sandwiches the stack of components downward against the flange 118 of the knuckle 106. The pressure nut 113 includes an inner diameter that is forced against the outer surface of the first shaft 204 to hold the pressure nut 113 in place.

Frictional contact is generated between the friction plates 107 and the upper carousel 108 that transmits torque from the first shaft 204. The frictional contact between the friction plates 107 and the upper carousel 108 enables the carousel to stop in the event a rigid object or other feature is stuck between the blades and creates a stoppage. Enabling the carousel 108 to stop protects the mechanism against damage.

Additionally, the knuckle 106 enables a loose fit that allows the upper carousel 108 to float and wobble above the lower carousel 104 to enable uniform contact and provide the desired scissoring cutting action between the blades 105, 114.

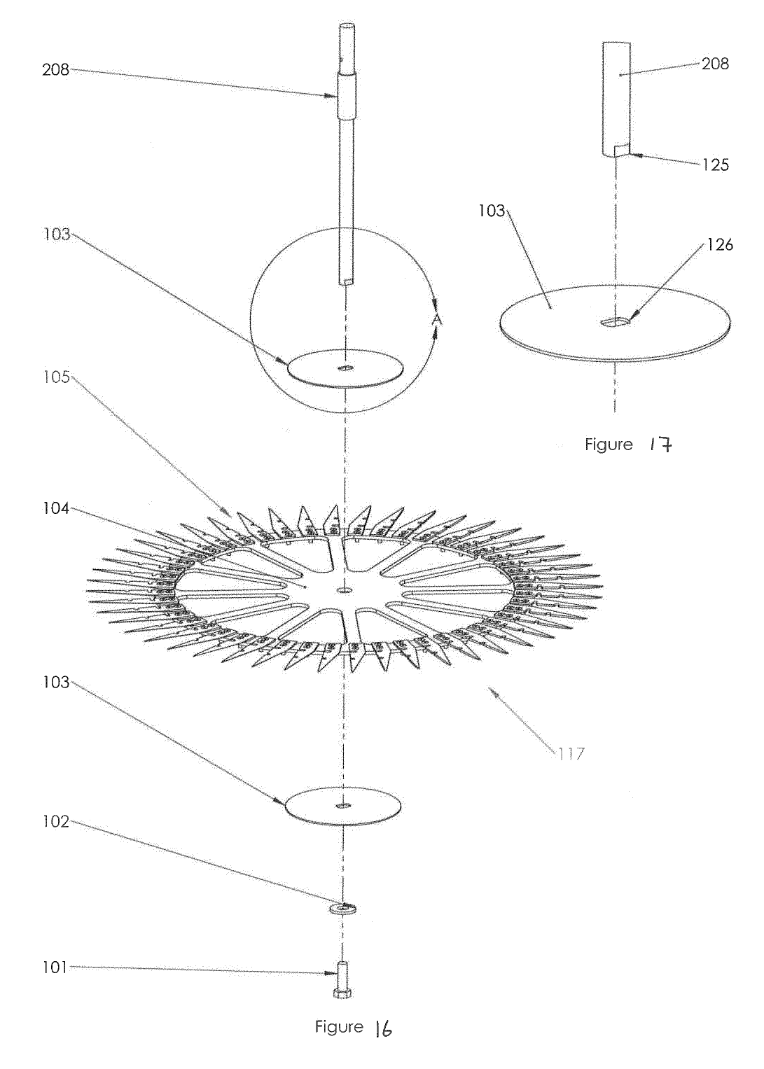

Referring to FIGS. 16 and 17 with continued reference to FIGS. 9 and 10, the lower blade assembly 117 includes a fastener 101 and washer 102 that holds the lower carousel 104 between friction plates 103 on an end of the second shaft 208. The friction plates 103 each include a non-round opening 126 keyed to a notch 125 at an end of the second shaft 208. The carousel 104 includes a round opening 127 and is not fixed to the second shaft 208. The fastener 101 sandwiches the lower carousel 104 between the friction plates 103 to provide frictional driving contact between with the lower carousel 104. Rotation of the second shaft 208 is transmitted to the lower carousel through the frictional contact with the friction plates 103. Accordingly, the lower carousel 104 may stop rotation relative to the second shaft 208 in the event that an object is stuck between the cutting blades to prevent damage to the mower mechanism and gear system.

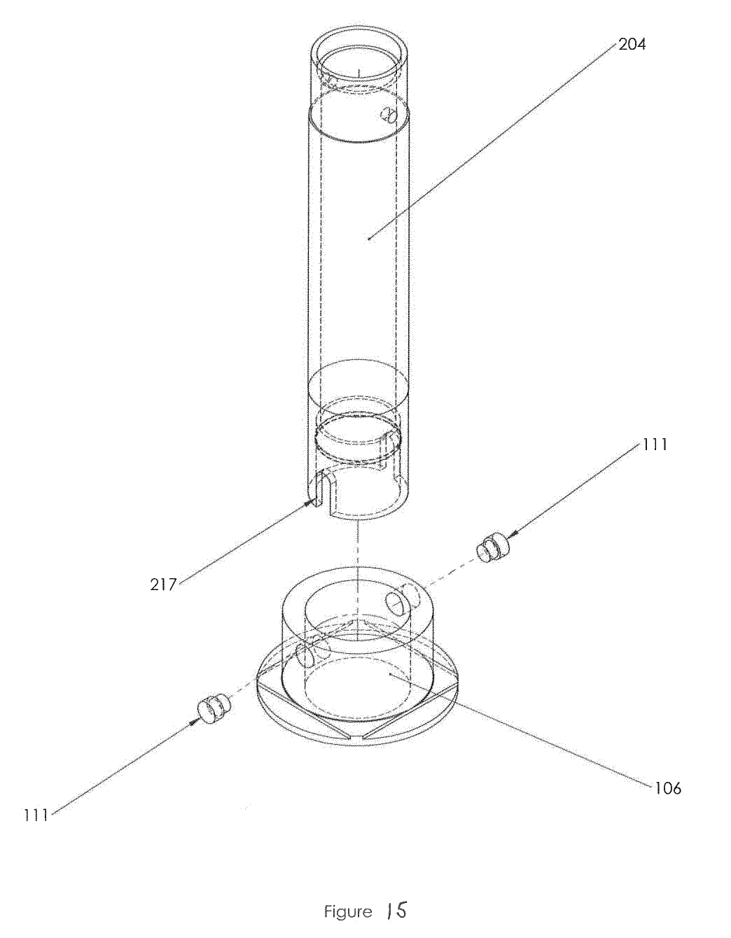

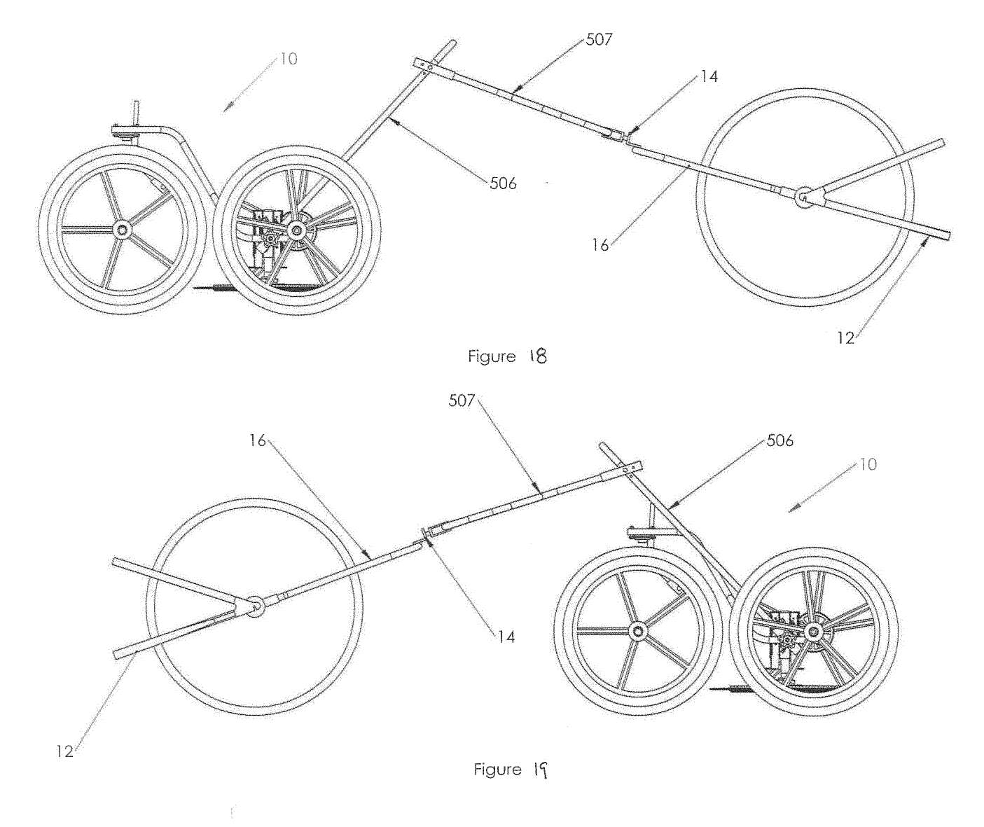

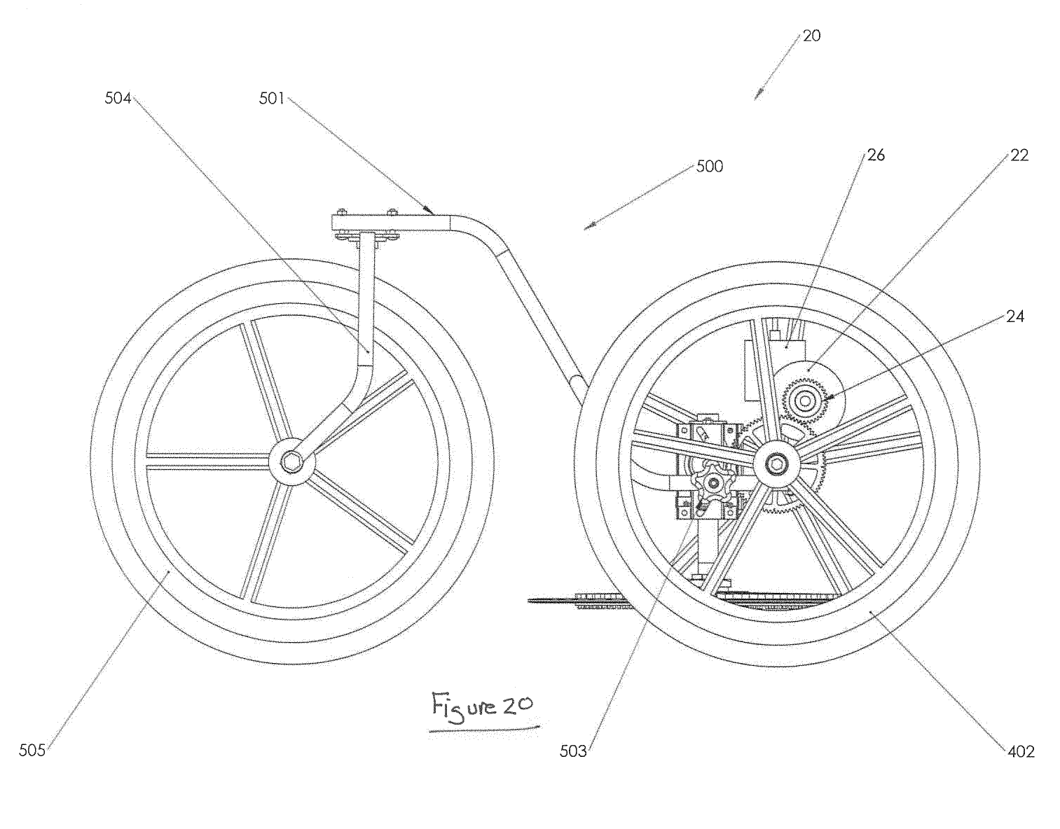

Referring to FIGS. 18 and 19, the mower 10 can be powered by a person on foot or riding a bicycle as in the embodiments shown in FIGS. 15 and 16.

The mower 10 may be attached and pulled by a bicycle 12. In one example, the mower 10 is pulled forward (FIG. 15) and attached by a link 16 and coupling 14 to the upper handle section 507. In another example, the mower 10 is pushed forward with the bike 12 behind the mower 20 as is shown in FIG. 16. The coupling 14 provides for swiveling movement between the link 16 and handle section 507 as may be needed to move the mower 10.

Referring to FIG. 20, another example mower 20 embodiment includes a motor 22 that drives a gear 24 engaged to the gear 403 to drive the cutting assembly 100. In this example, the motor 22 is electric and includes a controller 26 that controls operation and may provide for autonomous operation. The electric motor 22 could be used to both propel the mower 20 and to drive the cutting assembly 100. The motor 22 could also be utilized just to drive the wheels 402 and that movement be utilized to drive the cutting assembly 100 as disclosed and described above. The controller 26 could drive the motor in a self-guided or pre-programmed manner to cut grass within a defined space. Moreover, the example chassis 500 could be modified to accommodate the electric motor 22 within the contemplation of this disclosure.

Accordingly, the example discloses mower assemblies include a cutting assembly that converts forward motion of the mower into rotary cutting action between opposing blades. The mower disclosed mower can be operated without a motor and use only the power provided by an operator pushing or pulling the mower.

This mower is scalable up or down, and can be modified to produce an optimum cut at many different sizes. Carousels 104, 108 are capable of holding different quantities and sizes of blades 105, 114. The blades 105, 114 can be made in different shapes and with various cutting angles to attain an optimum cut. Based on the shape and number of blades, the distance travelled per cutting event can be modified according to the equation listed above. Gears 212 and 403 can be changed in order to attain a different gear ratio, which has the effect of increasing/decreasing required power input and changing the quality of cut. Alternative materials for carousels 104, 108 can be used to provide a desired spring effect observed on each individual cutting blade. For example the carousels 104 and 108 can be built using either steel or polymers to produce the required springing effect.

Although an example embodiment has been disclosed, a worker of ordinary skill in this art would recognize that certain modifications would come within the scope of this disclosure. Example modification within the scope and contemplation of this disclosure include making separate parts integral and integral parts separate parts. Moreover, although a specific configuration and shape is disclosed for each of the components, other shapes, configurations and combination of components are within the scope and contemplation of this disclosure. For these reasons, the following claims should be studied to determine the scope and content of this disclosure.

What is claimed is:

1. A mower assembly comprising:
a first shaft rotatable in a first direction about an axis;
a second shaft rotatable in a second direction opposite the first direction about the axis;
an first set of cutting blades driven by the first shaft for rotation about the axis in the first direction, the first set of cutting blades facing in the first direction;
a second set of cutting blades driven by the second shaft for rotation about the axis in the second direction opposite the first set of cutting blades defining a cutting zone between opposing ones of the first set of cutting blades and the second set of cutting blades.

2. The mower assembly as recited in claim 1, including an upper carousel supporting the first set of blades and a lower carousel supporting the second set of blades.

3. The mower assembly as recited in claim 2, wherein at least one of the first set of blades and the second set of blades is biased into rotating contact with the other of the first set of blades and the second set of blades.

4. The mower assembly as recited in claim 2, wherein the upper carousel is formed from a flexible steel material and each of the first set of cutting blades is angled downward to biases each of the first set of cutting blades individually against the second set of blades attached to the lower carousel.

5. The mower assembly as recited in claim 4, wherein the first set of cutting blades are biased into contact with the second set of cutting blades to generate a continuous scissoring motion when rotated in opposite directions.

6. The mower assembly as recited in claim 3, including a wobbling knuckle assembly driving rotation of the upper carousel, the wobbling knuckle assembly defines relative movement between the first shaft and the upper carousel such that the upper carousel and the first set of blades is moveable to bias against the lower carousel and the second set of blades.

7. The mower assembly as recited in claim 6, wherein the wobbling knuckle assembly includes a drive tube knuckle coupled to the first shaft and supporting the upper carousel between a lower friction plate and an upper friction plate, wherein rotation of the drive tube knuckle is transmitted to the upper carousel through frictional contact with the upper friction plate and the lower friction plate.

8. The mower assembly as recited in claim 7, wherein the drive tube knuckle includes a flange keyed to engage the lower friction plate.

9. The mower assembly as recited in claim 7, wherein wobbling knuckle assembly further includes torque pins coupling the drive tube knuckle to the first shaft, an upper blade locator coupled to the upper friction plate and a pressure nut holding a biasing washer against a retainer that in turn biases the upper friction plate against the upper carousel.

10. The mower assembly as recited in claim 7, wherein the first shaft comprises a hollow tube and the second shaft comprises a solid shaft extending through the first shaft and the drive tube knuckle.

11. The mower assembly as recited in claim 9, including a first friction plate disposed on a top side of the lower carousel and a second friction plate disposed on a bottom sides of the lower carousel, the first and second friction plates coupled for rotation with the second shaft, wherein rotation of the second shaft is transmitted to the lower carousel through frictional contact with the first friction plate and the second friction plate.

12. The mower assembly as recited in claim 1, including a gearbox having a first gear driving the first shaft and a second gear driving the second shaft, the first gear and the second gear both engaged to a drive gear, the drive gear driving the first gear in the first direction and the second gear in the second direction.

13. The mower assembly as recited in claim 12, including a drive shaft coupled to drive the drive gear, the drive shaft supported about a second axis transverse to the first axis.

14. The mower assembly as recited in claim 13, including a drive axle coupled to wheels supporting movement of the mower, the drive axle including a driven gear coupled to drive the drive gear on the drive shaft responsive to movement of the mower.

15. The mower assembly as recited in claim 14, wherein the drive axle is supported within a chassis, the chassis including an adjustment mechanism for adjusting a cutting height of the first and second set of cutting blades.

16. The mower assembly as recited in claim 15, including a motor for driving the drive shaft.

17. A method of operating a mower for cutting vegetation comprising:
driving a first set of cutting blades about an axis in a first direction, the first set of cutting blades facing in the first direction;
biasing the first set of cutting blades against a second set of cutting blades; and
driving the second set of cutting blades about the axis in a second direction opposite the first set of cutting blades through a cutting zone between opposing ones of the first set of cutting blades and the second set of cutting blades.

18. The method as recited in claim 17, wherein driving the first set of blades comprises supporting the first set of cutting blades between an upper friction plate and a lower friction plate, supporting the second set of cutting blades between a first friction plate and a second friction plate, coupling the upper friction plate and the lower friction plate to a first shaft, coupling the first friction plate and the second friction plate to a second shaft and driving the first shaft and the second shaft in opposing directions about the axis.

19. The method as recited in claim 18, wherein the first shaft is a hollow tube and the second shaft extends through the hollow tube.

20. The method as recited in claim 19, wherein a drive axle is coupled to wheels supporting movement of the mower and the drive axle drives rotation of the first and second shafts through a gear box responsive to movement of the mower.
